(19) United States
(12) Patent Application Publication
(10) Pub. No.: US 2011/0051010 A1
(43) Pub. Date: Mar. 3, 2011

(54) Encoding Video Using Scene Change Detection

(76) Inventors: Rami Jiossy, Haifa (IL); Ofer Rosenberg, Yokneam (IL)

(21) Appl. No.: 12/548,500

(22) Filed: Aug. 27, 2009

(51) Int. Cl. H04N 5/14

(52) U.S. Cl. 348/700; 348/E05.067

(57) ABSTRACT

A scene change detection may be made prior to motion estimation and intraframe prediction and the overhead of the prediction stage may be reduced and the scene change detection algorithm may not be dependent on motion estimation accuracy. In some cases, an indication of a scene change may be provided, together with a level of confidence indication. In some embodiments, a window of a plurality of frames may be analyzed to determine whether or not a scene change has occurred.

### BACKGROUND

This relates generally to graphics processing and, particularly, to encoding or compressing video information.

Generally, video information is encoded or compressed so that it takes up less bandwidth in various transmission schemes. Whenever video is going to be transmitted, it can be transmitted more efficiently if it is compressed. In addition, narrower bandwidth channels may be used to convey compressed information.

Generally, compression algorithms take advantage of similarities between successive frames to reduce the complexity of the coding process and to reduce the amount of information involved in encoding. Thus, scene changes are commonly detected as part of the encoding process. As used herein, a scene change may include a scene cut or content change, a fade or lighting change, a zoom, or a translation or camera movement.

### BRIEF DESCRIPTION OF THE DRAWINGS

FIG. 1 is a schematic depiction of an encoder in accordance with one embodiment;

FIG. 2 is a flow chart for one embodiment;

FIG. 3 is a depiction of a sequence of frames within a window in accordance with one embodiment; and

FIG. 4 is a depiction of a system in accordance with one embodiment.

### DETAILED DESCRIPTION

In accordance with some embodiments, a scene change may be detected early on in the encoding sequence. In some embodiments, this may mean that the scene change may be detected in the order in which frames are displayed, in contrast to current treatments, that may use the encoding order. In some cases, earlier scene change detection may reduce the overhead of the prediction stage. In some embodiments, the scene change detection algorithm may not be dependent on motion estimation accuracy.

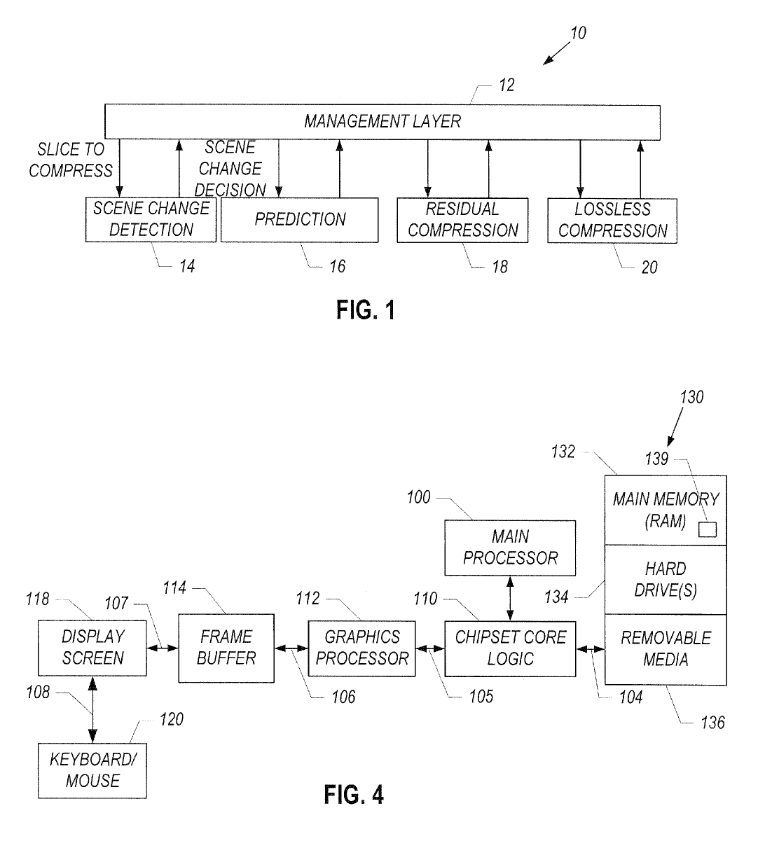

Thus, referring to FIG. 1, an encoder 10 may include a scene change detection stage 14 which receives a slice of video to compress and provides a scene change decision to a management layer 12. Then the prediction module 16 undertakes motion estimation and intraframe prediction. It processes the so-called P and B slices (or frames under older standards). Because the scene change decision is already made, prediction may be used only as necessary based on the location of the scene change, in some embodiments. Then residual compression 18 and lossless compression 20 may be completed.

As a result, motion prediction results are not necessary to determine whether there is a scene change or not. The scene change detector is then disconnected from the motion prediction module, enabling a separate light weight module at the early encoding phase, in some embodiments. In addition, redundant motion prediction work may be reduced in the case of some scene changes and, most importantly, may make early group of pictures (GOP) structuring decisions in some embodiments.

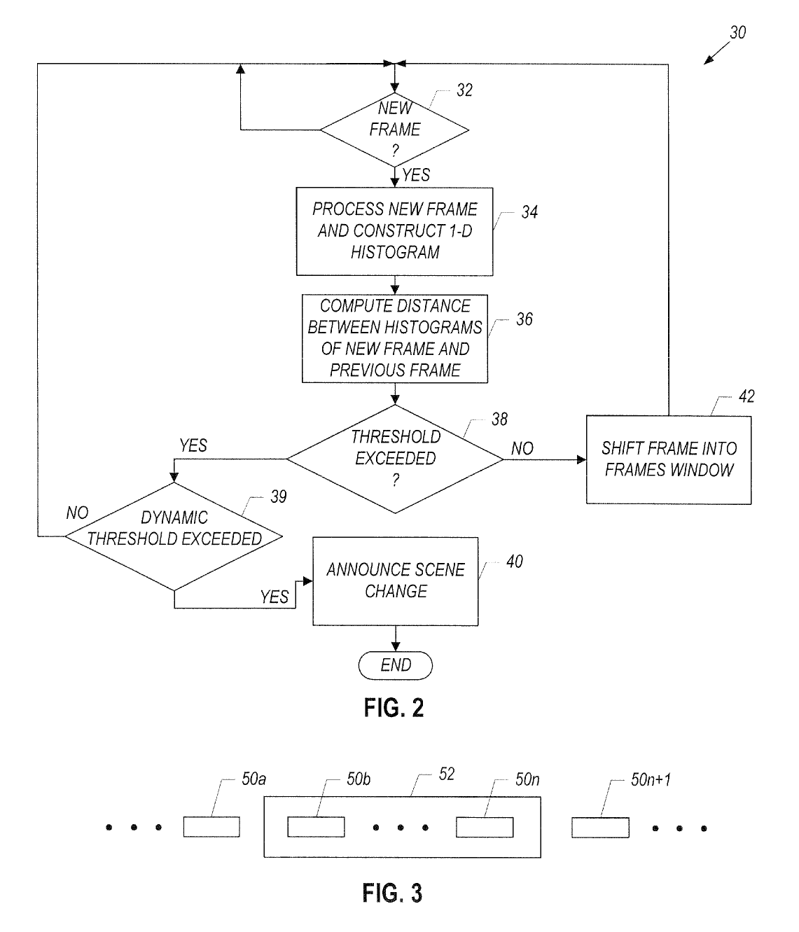

In accordance with some embodiments, the scene change detection 14 may be implemented by a sequence 30, shown in FIG. 2. The sequence 30 may be implemented in software, hardware, or firmware. In software embodiments, a sequence of instructions may be executed by a computer. The instructions may be stored on a computer readable medium such as an optical storage, a magnetic storage, or a semiconductor storage.

The encoder of FIG. 1 may be consistent with the H.264 (advanced video codec (AVC) and MPEG-4 Part 10), compression standard, for example. The H.264 standard has been prepared by the Joint Video Team (JVT), which includes ITU-T SG16 Q.6, also known as VCEG (Video Coding Expert Group), and of the ISO-IEC JTC1/SC29/WG11 (2003), known as MPEG (Motion Picture Expert Group). H.264 is designed for applications in the area of digital TV broadcast, direct broadcast satellite video, digital subscriber line video, interactive storage media, multimedia messaging, digital terrestrial TV broadcast, and remote video surveillance, to mention a few examples.

While one embodiment may be consistent with H.264 video coding, the present invention is not so limited. Instead, embodiments may be used in a variety of video compression systems including MPEG-2 (ISO/IEC 13818-1 (2000) MPEG-2 available from International Organization for Standardization, Geneva, Switzerland) and VC1 (SMPTE 421M (2006) available from SMPTE White Plains, N.Y. 10601).

Incoming frames are processed by the sequence 30 in uncompressed format ordered by presentation order. Thus, the frames are in the sequence in which they will be presented on the ultimate display. The output of the scene change detection stage may be two values in one embodiment. The first value may indicate a decision as to whether there is a scene change or not and the second value gives a confidence level for the decision. The decision may be a yes or no indication of whether the last frame fed into the scene change detector signals the start of a new scene. The confidence level may be a value in the range of 0 to 100 percent, indicating how much the scene change detector is confident about the decision it has made. This indication may be approximated by measuring the distance from a dynamic threshold. In some embodiments, this may be utilized by the management layer 12 to conduct a more informed GOP sizing decision.

In accordance with some embodiments, the sequence 30 relies on comparing frame histograms. These histograms give counts of the number of pixel values that are the same. In some embodiments, these pixel values may be pixel values for the Luma or y component of YUV video. As another example, the chroma or U component of YUV video may be used.

On a scene change, often a new frame will have different objects than the previous frame. Those objects may be placed differently with different lighting. A frame histogram encompasses this new information, including the light changes. Therefore, from the point of view of most manageability engines, detecting histogram changes is enough for announcing a new GOP and encoding the following frame as a new I frame.

Thus, initially when a new frame arrives (diamond 32), the new frame is processed and a one dimensional histogram of pixel Luma values is constructed, in one embodiment, as indicated in block 34. A distance is computed between the histogram of the new frame and that of a previous frame (block 36). If a threshold is exceeded (diamond 38), a scene change may be announced (block 40), after an additional check at diamond 39, explained later. Otherwise, another frame is shifted into a frame window, as indicated in block 42.

Thus, referring to FIG. 3, a sequence of frames 50 may be processed in display order. A window 52 may be provided around a predetermined number of frames. In some embodiments, this number of frames is selected by the user. The more frames that are used, in some cases, the more accurate the scene change detection algorithm will be, but the more processing overhead that may be involved. Thus, a check decides whether or not to shift another frame into the window (block 42). If the threshold is not exceeded (diamond 38) for determining a scene change, the next frame, such as frame 50a, is shifted into the window 52 and the last frame 50n is shifted out.

The determination of histogram distance may rely on measuring histogram difference D in a simple normalized sum of absolute differences between two histograms (H1 and H2):

$$D ( H 1 , H 2 ) = \frac{{\sum }_{0}^{N - 1} \vert H 1 [ i ] - H 2 [ i ] \vert}{2 N}$$

where N is the number of histogram bins. In some embodiments, this may amount to determining a bin-to-bin distance. Instead of using sum of absolute differences, many other methods may be used, including chi-square or histogram intersection, to mention a few examples.

The above metric may be applied on incoming frames by construction a one dimensional histogram for each incoming frame and calculating its difference from the previous frame's histogram. This calculated distance estimates how much those frames differ from each other. Later this value can be compared with the average distance in a managed frame window 52 and compared against a dynamic threshold (diamond 39).

In dynamic thresholding, implemented in diamond 39 in FIG. 2, a single threshold is not used for all video types and scenes because there is no single threshold that matches them all. Hence, in dynamic thresholding, the threshold is estimated adaptively along with the sequence of frames and is reset on each scene change since each new scene may differ in nature from previous ones.

The threshold (T) may be calculated from the managed frame windows according to the following formula:

T=A*Mean(w)+B*Std(w)

where mean(w) is the mean of the difference between consecutive frame histograms within the window, std(w) is the standard deviation of the differences between consecutive frame histograms within the last window and A and B are the parameters that determine the character of the thresholding function and may be set according to the intended application. In some applications, A can be set equal to 1 and B can be set equal to 1. Using higher values for A and B makes the scene change more rigid in that it is limited to drastic scene or illumination changes. That may be useful in motion detection applications. Higher values reduce the detection of frames with intense motion as a scene changes. Using low values may be useful in applications like bit rate control.

Thus, if a first static threshold is exceeded in diamond 38 (FIG. 2), a check at diamond 39 determines whether the dynamic threshold is exceeded, in one embodiment. If so, a scene change is announced (block 40). Otherwise, the flow iterates.

A computer system 130, shown in FIG. 4, may include a hard drive 134 and a removable medium 136, coupled by a bus 104 to a chipset core logic 110. The core logic may couple to the graphics processor 112 (via bus 105) and the main or host processor 100 in one embodiment. The graphics processor 112 may also be coupled by a bus 106 to a frame buffer 114. The frame buffer 114 may be coupled by a bus 107 to a display screen 118, in turn coupled to conventional components by a bus 108, such as a keyboard or mouse 120.

In the case of a software implementation, the pertinent code to implement the sequence of FIG. 2 may be stored in any suitable semiconductor, magnetic or optical memory, including the main memory 132. Thus, in one embodiment, code 139 may be stored in a machine readable medium, such as main memory 132, for execution by a processor, such as the processor 100 or the graphics processor 112.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
identifying a scene change prior to a motion estimation and intraframe prediction in a video encoder.

2. The method of claim 1 including detecting a scene change by taking a histogram of pixel values.

3. The method of claim 2 including taking a histogram of only one of the Luma or chroma values.

4. The method of claim 1 including determining the difference between a histogram of a present frame and a previous frame and using said difference to analyze whether a scene change has occurred.

5. The method of claim 4 including analyzing a series of frames within a window and determining for those frames how a current frame differs from a plurality of previous frames.

6. The method of claim 5 including calculating a threshold based on the mean of the difference between consecutive frame histograms within the window and the standard deviation of the differences between consecutive frame histograms within the window and using that as a threshold to determine whether to announce a scene change.

7. The method of claim 4 including determining the difference between the normalized sum of absolute differences between two histograms in order to determine whether a scene change has occurred.

8. The method of claim 1 including providing an indication of whether a scene change may have occurred together with a level of confidence in the scene change indication.

9. A computer readable medium storing instructions executed by a computer to:
identify a scene change prior to a motion estimation and intraframe prediction in a video encoder.

10. The medium of claim 9 further storing instructions to detect a scene change by taking a histogram of pixel values.

11. The medium of claim 10 further storing instructions to use the Luma values of a plurality of pixels to create the histogram.

12. The medium of claim 11 further storing instructions to provide an indication of whether a scene change has occurred and a level of confidence in the scene change indication.

13. The medium of claim 9 further storing instructions to analyze differences between more than two frames in a window to determine whether a scene change has occurred.

14. An encoder comprising:
a scene change detection module to receive a video slice and to indicate a scene change; and
a prediction module to receive said video slice and said scene change detection indication.

15. The encoder of claim 14, said scene change detection module to predict scene changes using a histogram of pixel values.

16. The encoder of claim 15 wherein said scene change detection module to use Luma values of a plurality of pixels to create the histogram.

17. The encoder of claim 16, said scene detection module to indicate whether a scene change has occurred together with a level of confidence in the scene change indication.

18. The encoder of claim 17, said scene detection module to analyze differences between more than two frames in a window to determine whether a scene change has occurred.

19. The encoder of claim 17 wherein said encoder to determine the difference between the normalized sum of absolute differences between two histograms of two successive frames to determine whether a scene change has occurred.

20. The encoder of claim 19, said encoder to calculate the mean of the difference between consecutive frame histograms within the window and the standard deviation of the differences between consecutive frame histograms within the window.
